(19) United States
(12) Patent Application Publication
(10) Pub. No.: US 2020/0052635 A1
(43) Pub. Date: Feb. 13, 2020

(54) METHOD FOR SEARCHING EXCITATION SIGNAL OF MOTOR, AND ELECTRONIC DEVICE

(71) Applicant: AAC Technologies Pte. Ltd., Singapore city (SG)

(72) Inventors: Xiang Lu, Shenzhen (CN); Zheng Xiang, Shenzhen (CN); Hanlin Deng, Shenzhen (CN); Liang Jiang, Shenzhen (CN)

(21) Appl. No.: 16/528,696

(22) Filed: Aug. 1, 2019

(30) Foreign Application Priority Data
Aug. 9, 2018 (CN) 201810900044.8

(51) Int. Cl. H02P 23/00; G06N 3/12; G05B 13/02; H02P 25/032; G08B 6/00

(52) U.S. Cl. CPC H02P 23/0077; G06N 3/126; G08B 6/00; H02P 25/032; G05B 13/0265

(57) ABSTRACT

A method for searching an excitation signal for a motor and an electronic device. The method includes: randomly generating M excitation signals for the motor, and determining whether the M excitation signals allow vibration sense obtained after the motor is driven to be expected vibration sense; if yes, outputting this excitation signal as an optimal excitation signal; if no, calculating the M excitation signals according to a preset genetic algorithm to obtain a new generation of M excitation signals, and then determining whether the new generation of M excitation signals allow vibration sense obtained after the motor is driven to be the expected vibration sense, until the optimal excitation signal is obtained. In the present disclosure, the optimal excitation signal for obtaining the expected vibration sense after the motor is driven can be quickly found, and thus an efficiency thereof is high.

### TECHNICAL FIELD

The present disclosure relates to the field of signal processing technologies, and in particular, to a method for searching an excitation signal for a motor and an electronic device.

### BACKGROUND

At present, many electronic devices are equipped with linear motors, and the linear motors are used to simulate physical buttons. In order to make tactile sense generated by vibration of the linear motor similar to effect of an actual physical button, analysis can be conducted during a process of depressing and returning a physical button to obtain a series of quantitative data, such as keycap acceleration, displacement, frequency, spectrum, etc., so that actual button effect is converted into quantitative data. When certain button effect needs to be generated by a linear motor, it is usually performed in a manner of traversal searching. Specifically, different excitation signals are input into the linear motor to generate corresponding tactile results, and when data representing the tactile results matches data representing button effect, an excitation signal of this tactile result is generated, that is, an excitation signal corresponding to this button effect is generated.

However, the inventor of the present disclosure found that it took millions times of traversal searching to find an excitation signal corresponding to a certain button effect when using the traversal searching method described above. Therefore, it is very difficult and time consuming.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 illustrates flowchart of a method for searching an excitation signal for a motor according to a first embodiment of the present disclosure;

FIG. 2 illustrates a flowchart of a method for searching an excitation signal for a motor according to a second embodiment of the present disclosure;

FIG. 3 illustrates a flowchart of a method for searching an excitation signal for a motor according to a third embodiment of the present disclosure;

FIG. 4 illustrates a flowchart of a method for searching an excitation signal for a motor according to a fourth embodiment of the present disclosure; and

FIG. 5 is a schematic diagram illustrating the searching of excitation signals according to the fourth embodiment of the present disclosure.

### DESCRIPTION OF EMBODIMENTS

The present disclosure will be further illustrated with reference to the accompanying drawings and the embodiments.

A first embodiment of the present disclosure relates to a method for searching an excitation signal for a motor, and the method is used to search and output an optimal excitation signal. A vibration sense obtained after the optimal excitation signal drives the motor is an expected vibration sense, and the motor herein can be a linear motor.

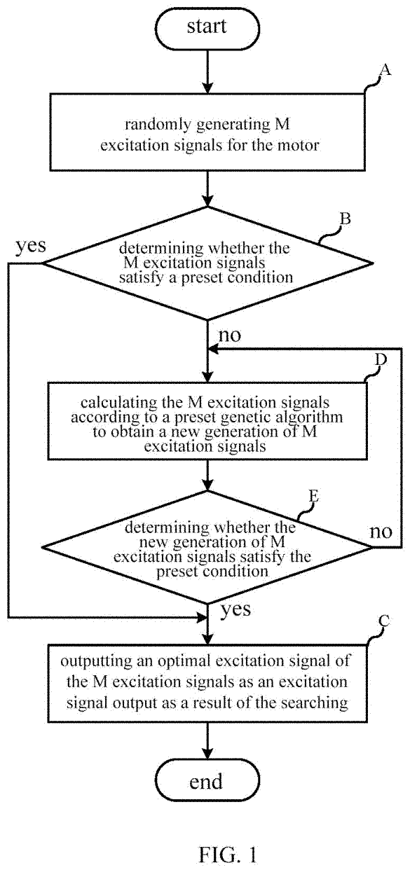

FIG. 1 illustrates a flowchart of the method for searching the excitation signal for the motor according to the first embodiment of the present disclosure.

At step A, M excitation signals for the motor are randomly generated.

Specifically, a vibration mode of the linear motor is a positive-negative alternating mode, and for the M excitation signals for the motor generated, each excitation signal can be divided into K sections, and each section includes a voltage value and a duration value. That is, each excitation signal includes K voltage values and K duration values. Herein, M and K are positive integers.

At step B, it is determined whether the M excitation signals satisfy a preset condition. If the M excitation signals satisfy the preset condition, step C is performed; and if the M excitation signals do not satisfy the preset condition, step D is performed.

Specifically, the preset condition refers to a test if an arbitrary one of the M excitation signals allows a vibration sense obtained after the motor is driven by the excitation signal to be an expected vibration sense, and then it is determined whether the M excitation signals satisfy this preset condition. That is, it is determined whether there is an excitation signal of the M excitation signals that allows the vibration sense obtained after the motor is driven by this excitation signal to be the expected vibration sense. If there is an excitation signal of the M excitation signals that allows the vibration sense obtained after the motor is driven by this excitation signal to be the expected vibration sense, step C is performed; and if none of the M excitation signals allows the vibration sense obtained after the motor is driven by any of the M excitation signals to be the expected vibration sense, step D is performed.

At step C, an optimal excitation signal of the M excitation signals is output as an excitation signal output as a result of the searching.

Specifically, since there is an excitation signal of the M excitation signals that allows the vibration sense obtained after the motor is driven by this excitation signal to be the expected vibration sense, then this excitation signal is an optimal excitation signal, i.e., an excitation signal output as a result of the searching, and then the optimal excitation signal is output.

At step D, the M excitation signals are calculated using a preset genetic algorithm to obtain a new generation of M excitation signals.

Specifically, the M excitation signals randomly generated are used as an initial species including M excitation signals, and each excitation signal includes K voltage values and K duration values. Then the initial species is calculated using a preset genetic algorithm to obtain a new species, and the new species includes a new generation of M excitation signals. Preferably, in this embodiment, floating-point number is used to represent each voltage value and each duration value, so as to achieve higher precision.

At step F, it is determined whether or not the new generation of M excitation signals satisfy a preset condition. If yes, step C is performed; and if not, step D is performed.

Specifically, it is determined whether an arbitrary one of the new generation of M excitation signals allows the vibration sense obtained after the motor is driven by this excitation signal to be the expected vibration sense. If there is an excitation signal of the M excitation signals that allows the vibration sense obtained after the motor is driven by this excitation signal to be the expected vibration sense, step C is performed, and an optimal excitation signal of the M excitation signals is output; and if none of the M excitation signals allows the vibration sense obtained after the motor is driven by any of the M excitation signals to be the expected vibration sense, step D is performed, and the new generation of M excitation signals is calculated using the preset genetic algorithm to obtain another new generation of M excitation signals, and step D is repeated until the optimal excitation signal corresponding to the expected vibration sense after the motor is driven by the excitation signal is obtained.

Compared with the prior art, in one embodiment of the present disclosure, M excitations signals for the motor are generated, and then it is determined whether an arbitrary on of the M excitation signals allows the vibration sense obtained after the motor is driven by this excitation signal to be the expected vibration sense. If there is an excitation signal of the M excitation signals that allows the vibration sense obtained after the motor is driven by this excitation signal to be the expected vibration sense, this excitation signal is the optimal excitation signal; and if none of the M excitation signals allows the vibration sense obtained after the motor is driven by any of the M excitation signals to be the expected vibration sense, the M excitation signals are calculated using a preset genetic algorithm to obtain a new generation of M excitation signals, and then it is determined again whether any arbitrary one of the new generation of M excitation signals allows the vibration sense obtained after the motor is driven by this excitation signal to be the expected vibration sense, until the optimal excitation signal is searched out. Due to fast searching capability of the genetic algorithm, the optimal excitation signal for obtaining the expected vibration sense after the motor is driven by the excitation signal can be quickly found when applying the genetic algorithm to the searching of the excitation signals for the motor, and thus the efficiency thereof is high.

A second embodiment of the present disclosure relates to a method for searching an excitation signal for a motor, which is an improvement on the basis of the first embodiment, and a main improvement is that a process of determining iteration times of the genetic algorithm is further provided.

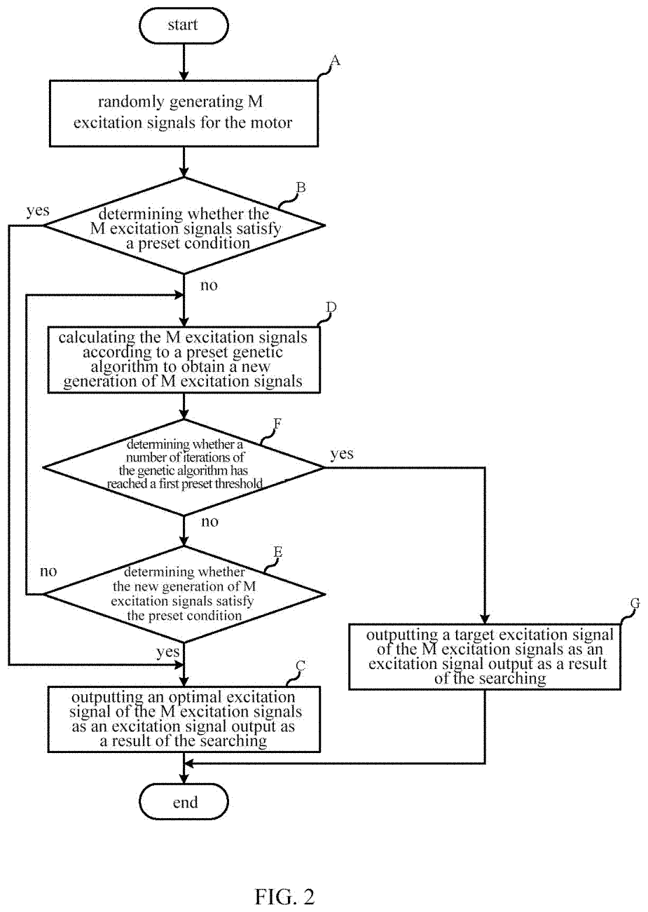

FIG. 2 illustrates a flowchart of the method for searching the excitation signal for the motor according to the second embodiment of the present disclosure;

Step A, step B, step C, step D, and step E in the second embodiment are substantially the same as step A, step B, step C, step D, and step E in the first embodiment, which will not be further described herein. The main difference of the method in the second embodiment from the method in the first embodiment is that step F and step G are provided as follows.

At step F, it is determined whether or not the iteration times of the genetic algorithm reach a first preset threshold. If yes, step C is performed:and if not, step E is performed.

Specifically, at step D, the M excitation signals are calculated according to the preset genetic algorithm to obtain a new generation of M excitation signals, and then it is determined whether the iteration times of the genetic algorithm reaches a first preset threshold. That is, during searching, there may be preset iteration times of the genetic algorithm. If iteration times of the genetic algorithm reach the preset iteration times, it means that iteration of the genetic algorithm is completed, in this case, step G is performed. If iteration times of the genetic algorithm do not reach the preset iteration times, it means that iteration of the genetic algorithm has not been completed yet, in this case, step E is performed to determine whether the new generation of M excitation signals satisfy the preset condition.

At step G, a target excitation signal of the M excitation signals is output as an excitation signal output as a result of the searching.

Specifically, among the new generation of M excitation signals, the excitation signal for obtaining a vibration sense closest to the expected vibration sense after the motor is driven by the excitation signal is the target excitation signal output as a result of the searching, and then the target excitation signal is output.

Compared with the first embodiment, in this embodiment, the iteration times of the genetic algorithm can be set as required to obtain the desired target excitation signal.

A third embodiment of the present disclosure relates to a method for searching an excitation signal for a motor, which is an improvement on the basis of the first embodiment, and a main improvement thereof is that an implementation manner for calculating the M excitation signals according to a preset genetic algorithm to obtain a new generation of M excitation signals is provided.

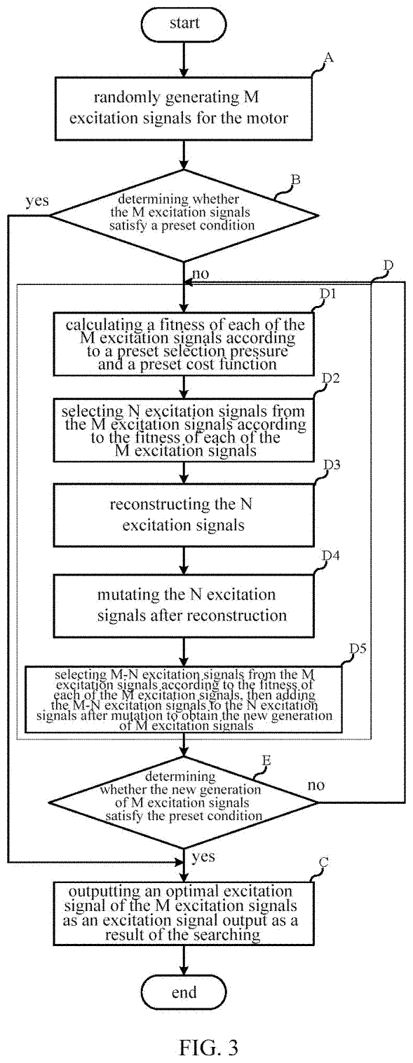

FIG. 3 illustrates a flowchart of a method for searching an excitation signal for a motor according to a third embodiment of the present disclosure.

Step A, step B, step C, and step E in the third embodiment are substantially the same as step A, step B, step C, and step E in the first embodiment, which will not be further described herein. The main difference of method in the third embodiment from the method in the first embodiment is that the step D in the third embodiment includes sub-steps as follows.

At sub-step D1, a fitness of each of the M excitation signals is calculated according to a preset selection pressure and a preset cost function.

Specifically, the M excitation signals are respectively input into a preset simulation model, and then vibration responses of the M excitation signals can be obtained. Then, the vibration responses of the M excitation signals arc respectively substituted into a preset cost function, and costs of the M excitation signals can be calculated. In this embodiment, a ranking-based fitness allocation method is adopted. Specifically, the costs of the M excitation signals are calculated, and the M excitation signals are ranked, in this case, the lower the cost, the higher the ranking,. Then, the fitness of each excitation is calculated based on a fitness calculation formula for linear ranking. The fitness calculation formula for linear ranking is as follows:

$$FitnV ( pos ) = 2 - sp + \frac{2 \times ( sp - 1 ) \times ( pos - 1 )}{Nind - 1}$$

Herein, pos represents the ranking of the excitation signals, Nind represents the total number of excitation signals, i.e., Nind=M, sp represents the selection pressure, and FitnV(pos) represents the fitness of the excitation signals ranked as pos.

In this embodiment, the cost function (also referred to as an object function) may be preset according to the expected vibration sense. The smaller the cost calculated according to the cost function, the closer the vibration sense to the expected vibration sense. For example, in a case where a total duration is determined, if it is required that a vibration amount is as large as possible and a brake amount is as small as possible, a following cost function ObjVal can be written as:

$$ObjVal = \frac{Gpp 2}{Gpp {1}^{2}}$$

Herein, Gpp1 represents an acceleration peak-to-peak value of vibration of a vibrator for the motor when the motor is driven by an excitation signal, and Gpp2 represents an acceleration peak-to-peak value of vibration of a vibrator for the motor when the motor is not driven by an excitation signal.

The selection pressure, also known as evolution pressure, is a pre-settable parameter within a range of [1, 2].

In the genetic algorithm, fitness indicates an ability of an individual to adapt to the environment, and also indicates an ability of the individual to breed offspring, and the fitness is an indicator used to determine an excellence level of the individuals in the species. In this embodiment, the fitness is an indicator for indicating an extent to which each of the M excitation signals is close to the optimal excitation signal.

It should be noted that, in this embodiment, the fitness of each excitation signal is calculated using the ranking-based fitness allocation method. However, this embodiment does not make any limitation on the method for calculating the fitness of excitation signal.

At sub-step D2, N excitation signals are selected from the M excitation signals according to the fitness of respective excitation signals.

Specifically, in this embodiment, N excitation signals may be selected from the M excitation signals, where N≤M and N is a positive integer. Herein, there arc two selection ways to select N excitation signals from the M excitation signals. In a first selection way, a random traversal sampling way is adopted. Firstly, a probability that each excitation signal is selected is calculated according to the fitness of each excitation signal, and the calculation formula is as follows:

$$F ( {x}_{i} ) = \frac{f ( {x}_{i} )}{{\sum }_{i = 1}^{Nind} f ( {x}_{i} )}$$

Herein, F(i) represents the probability for an i^{th} excitation signal to be selected, f(i) represents the fitness of the i^{th} excitation signal, and Nind represents the total number of excitation signals, i.e., Nind=M.

Then, based on the calculated probability that each excitation signal is selected, N excitation signals are selected equidistantly from the M excitation signals.

In the second selection way, a roulette way is adopted, and the probability that each excitation signal is selected is calculated in the same way as that in the random traversal sampling. Then a roulette is constructed based on the probability that each excitation signal is selected, and a roulette selection is performed. In this way, N excitation signals are selected, herein, the higher the fitness of the excitation signal is, the greater the probability that the excitation signal is selected.

It should be noted that only two ways for selecting N excitation signals from the M excitation signals are schematically provided in this embodiment. However, this embodiment does not make any limitation on this, and other ways, such as a tournament selection way, may also be adopted for selecting N excitation signals from the M excitation signals.

At sub-step D3, the N excitation signals are reconstructed.

Specifically, there are various reconstruction ways for reconstructing the N excitation signals, for example, a discrete reconstruction way, a linear reconstruction way, an intermediate reconstruction way, and the like. Specifically, each excitation signal includes K voltage values and K duration values, and in this embodiment, for each excitation signal of the N excitation signals, the K voltage values are interchanged randomly and the K duration values are interchanged randomly, so that the N excitation signals after reconstruction can be obtained.

At sub-step D4, the N excitation signals after reconstruction are mutated.

Specifically, according to a preset mutation rate, J excitation signals are selected from the N excitation signals after reconstruction. For example, if the mutation rate is K ∈ (0,1), then J=N*K. If J is not an integer, then adopts the nearest larger integer. Then a voltage value range and a duration value range of the selected J excitation signals are obtained, and then the K voltage values of each of the J excitation signals are increased or decreased by half of the voltage value range, and the K duration values of each of the J excitation signals are increased or decreased by half of the duration value range, so that the J excitation signals after mutation can be obtained. Herein, if a certain voltage value of the K voltage values of a certain excitation signal is smaller than half of the voltage value range, or if a certain duration value of the K duration values of a certain excitation signal is smaller than half of the duration value range, then it is needed to limit the voltage value range or the duration value range, for example, to keep the voltage value or duration value at the original value.

At sub-step D5, according to the fitness of each excitation signal, (M-N) excitation signals are selected from the M excitation signals, and then the selected (M-N) excitation signals are added to the N excitation signals after mutation, so as to obtain a new generation of M excitation signals.

Specifically, according to the fitness of each of the M excitation signals, (M-N) excitation signals are selected from the M excitation signals based on an order from high fitness to low fitness, and then (M-N) excitation signals are added to the N excitation signals after mutation. In this way, a new generation of M excitation signals is obtained, which is a new species, and then the (M-N) excitation signals with higher fitness in a previous species are added into the new species, which is advantageous to robustness of the entire species.

Compared with the first embodiment, the third embodiment provides an implementation manner for calculating M excitation signals according to a preset genetic algorithm to obtain a new generation of M excitation signals. It should be noted that the present embodiment may also be an improvement on the basis of the second embodiment, in which case the same technical effect can be obtained.

A fourth embodiment of the present disclosure relates to a method for searching an excitation signal for a motor, which is an improvement based on the first embodiment, and a main improvement thereof is that an implementation manner is provided for determining whether the M excitation signals satisfy a preset condition.

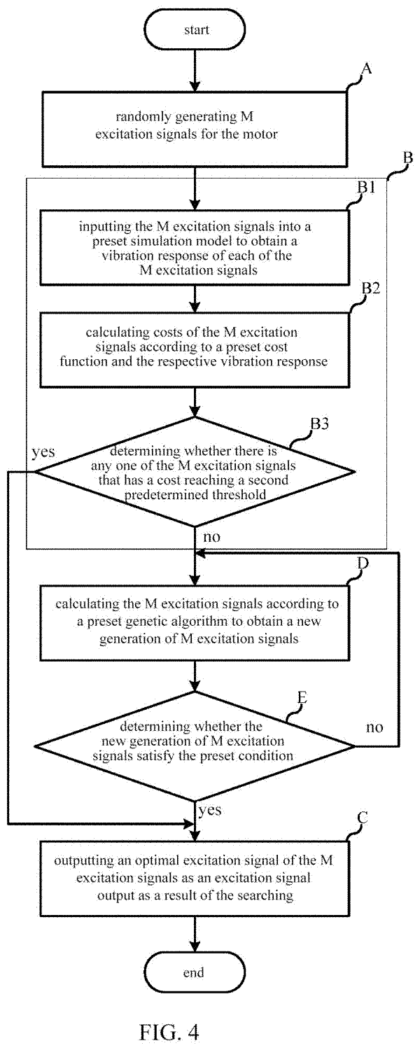

FIG. 4 illustrates a flowchart of a method for searching for an excitation signal for a motor according to a fourth embodiment of the present disclosure.

Step A, step C, step D, and step h in the fourth embodiment are substantially the same as step A, step C, step D, and step E in the first embodiment, which will not be further described herein. The main difference of the method in the fourth embodiment from the method in the first embodiment is that the step B in the fourth embodiment includes sub-steps as follows.

At sub-step B1, the M excitation signals are respectively input into a preset simulation model, and a respective vibration response of each excitation signal of the M excitation signals is obtained.

Specifically, the M excitation signals are respectively input into a preset simulation model, so that a respective vibration response of each excitation signal of the M excitation signals can be obtained. It should be noted that, in this embodiment, the M driving signals may also be respectively input into the motor, and the vibration response corresponding to each excitation signal can he obtained by detecting vibration for the motor.

At sub-step B2, the costs of the M excitation signals are calculated according to the preset cost function and the vibration response.

Specifically, the M vibration responses are respectively substituted into a preset cost function, and the costs, of the M vibration responses, i.e., the costs of the M excitation signals, are calculated.

At sub-step B3, it is determined whether there is an excitation signal of the excitation signals that has the cost reaching a second preset threshold. If there is an excitation signal of the excitation signals that has the cost reaching the second preset threshold, step C is performed; and if none of the excitation signals has the cost reaching the second preset threshold, step D is performed.

Specifically, if there is an excitation signal of the M excitation signals that has the cost reaching the second preset threshold, it means that the vibration sense obtained after this excitation signal drives the motor is an expected vibration sense, that is, this excitation signal is an optimal excitation signal. Herein, the second preset threshold may be set according to a test requirement.

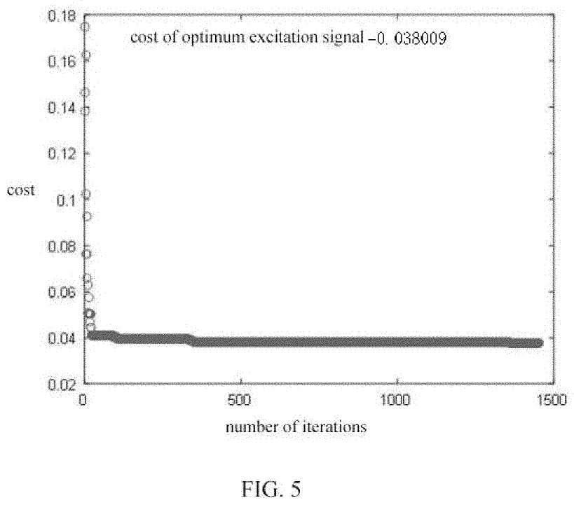

It should be noted that, in this embodiment, step B is taken as an example to illustrate how to determine whether the M excitation signals satisfy the preset condition. In step E, the above method can also be used to determine whether the new generation of M excitation signals satisfy the preset condition. According to the above method, it is determined whether the new generation of M excitation signals satisfy the preset condition, so that the optimal excitation signal of this generation of M excitation signals can be obtained for each iteration of the genetic algorithm. FIG. 5 is a schematic diagram illustrating the searching of excitation signals. Taking FIG. 5 as an example, the cost of the optimal excitation signal of the M excitation signals in each iteration is presented. After less than 1500 iterations, the cost of the optimal excitation signal of the new generation of M excitation signals is 0.038. It can be seen from the figure that if the second preset threshold is smaller than 0.038, the genetic algorithm can be used to continue the iteration until the cost of an excitation signal of a certain generation of M excitation signals reaches the second preset threshold. Herein, if it is needed to speed up a convergence speed of the genetic algorithm, then the mutation rate, reconstruction way and cost function of the genetic algorithm can be adjusted accordingly.

Compared with the first embodiment, this embodiment provides an implementation manner for determining whether the M excitation signals satisfy the preset condition. It should be noted that this embodiment can also be an improvement on the basis of the second embodiment or the third embodiment, in which case the same technical effect can be obtained.

A fifth embodiment of the present disclosure relates to an electronic device, such as a test host, in which a corresponding software program is installed. The electronic device includes at least one processor, and a memory in communication with the at least one processor. The memory stores instructions executable by the at least one processor, and the instructions are executed by the at least one processor to enable the at least one processor to perform the method for searching an excitation signal for a motor according to any one of the first to fourth embodiments.

Herein, the memory and the processor are interconnected by a bus. The bus may include any number of interconnected buses and bridges, and the bus connects one or more processors with various circuits of the memory. As is well known in the art, the bus can also connect various other circuits, such as peripheral devices, voltage regulators, and power management circuits. Therefore, it will not be further described herein. The bus interface provides an interface between the bus and a transceiver. The transceiver may be an element or a plurality of elements, such as multiple receivers and transmitters, providing units for communicating with various other devices on a transmission medium. Data processed by the processor is transmitted on a wireless medium via an antenna. Further, the antenna also receives data and transmits the data to the processor.

The processor is responsible for managing the bus and normal processing, as well as providing various functions including timing, peripheral interfaces, voltage regulation, power management, and other control functions. The memory can be used to store data used by the processor when performing operations.

A sixth embodiment of the present disclosure relates to a computer readable storage medium storing a computer program. The above method embodiments are implemented when the computer program is executed by the processor.

It should be understood by those skilled in the art that all or part of the steps in the embodiments described above can be implemented by a corresponding hardware instructed by a program, and the program is stored in a storage medium including a plurality of instructions for enabling a device (such as a microcontroller, a chip and the like) or a processor to execute all or part of the steps in the embodiments of the present disclosure. The abovementioned storage medium includes any medium that can store programming codes, such as a U disk, a mobile hard disk, a read-only memory (ROM), a random access memory (RAM), a magnetic disk, an optical disk, and the like.

It should be understood by those skilled in the art that the above embodiments are merely some specific embodiments of the present disclosure, and various changes in formality and details may be made without departing from the scope of the present disclosure.

What is claimed is:

1. A method for searching an excitation signal for a motor, comprising:
step A of randomly generating M excitation signals for the motor, wherein M is a positive integer;
step B of determining whether the M excitation signals satisfy a preset condition, wherein the preset condition is satisfied when any one of the M excitation signals allows a vibration sense obtained after the motor is driven by the one excitation signal to he an expected vibration sense; performing step C if the M excitation signals satisfy the preset condition, or performing step D if the M excitation signals do not satisfy the preset condition;
step C of outputting an optimal excitation signal of the M excitation signals as an excitation signal output as a result of the searching, wherein the optimal excitation signal is the excitation signal that allows the vibration sense obtained after the motor is driven by the excitation signal to be the expected vibration sense;
step D of calculating the M excitation signals according to a preset genetic algorithm to obtain a new generation of M excitation signals; and
step E of determining whether the new generation of M excitation signals satisfy the preset condition; performing the step C if the new generation of M excitation signals satisfy the preset condition, or performing the step D if the new generation of M excitation signals do not satisfy the preset condition.

2. The method as described in claim 1, wherein after the step D and before the step E, the method further comprises:
step F of determining whether a number of iterations of the genetic algorithm has reached a first preset threshold; performing the step E if the number of iterations of the genetic algorithm has not reached the first preset threshold, or performing step G if the number of iterations of the genetic algorithm has reached the first preset threshold;
step G of outputting a target excitation signal of the M excitation signals as an excitation signal output as a result of the searching, wherein the target excitation signal is an excitation signal that allows a vibration sense obtained alter the motor is driven by the excitation signal to be closest to the expected vibration sense.

3. The method as described in claim 1, wherein the step D comprises:
calculating a fitness of each of the M excitation signals according to a preset selection pressure and a preset cost function;
selecting N excitation signals from the M excitation signals according to the fitness of each of the M excitation signals, where N≤M and N is a positive integer;
reconstructing the N excitation signals;
mutating the N excitation signals after reconstruction;
selecting M-N excitation signals from the M excitation signals according to the fitness of each of the M excitation signals, then adding the NI-N excitation signals to the N excitation signals-after mutation to obtain the new generation of M excitation signals.

4. The method as described in claim 3, wherein the selecting N excitation signals from the M excitation signals according to the fitness of each of the M excitation signals comprises:
selecting N excitation signals from the N4 excitation signals according to the fitness of each of the M excitation signals by random traversal sampling.

5. The method as described in claim 3, wherein the selecting N excitation signals from the M excitation signals according to the fitness of each of the M excitation signals comprises:
selecting N excitation signals from the M excitation signals according to the fitness of each of the M excitation signals by roulette selection.

6. The method as described in claim 3, wherein each excitation signal comprises K voltage values and K duration values, where K is a positive integer;
the reconstructing the N excitation signals comprises: randomly interchanging the K voltage values of each of the N excitation signals, and randomly interchanging the K duration values of each of the N excitation signals.

7. The method as described in claim 3, wherein the mutating the N excitation signals after reconstruction comprises:
randomly selecting J excitation signals from the N excitation signals after reconstruction according to a preset mutation rate, where J≤N and N is a positive integer;
obtaining a voltage value range and a duration value range of each of the excitation signals; and
increasing or decreasing K voltage values of each of the J excitation signals by a half of the voltage value range, and increasing or decreasing K duration values of each of the J excitation signals by a half of the duration value range.

8. The method as described in claim 1, wherein the step B comprises:
inputting the M excitation signals into a preset simulation model to obtain a vibration response of each of the M excitation signals;
calculating costs of the M excitation signals according to a preset cost function and the respective vibration response;
determining whether there is any one of the M excitation signals that has a cost reaching a second predetermined threshold;
determining that the M excitation signals satisfy the preset condition when there is at least one of the M excitation signals that has the cost reaching the second predetermined threshold, or
determining that the M excitation signals do not satisfy the preset condition when none of the M excitation signals has the cost reaching the second predetermined threshold.

9. An electronic device, comprising:
at least one processor; and
a memory in communication with the at least one processor,
wherein the memory stores instructions executable by the at least one processor, and the instructions are executed by the at least one processor to enable the at least one processor to perform the method as described in claim 1.

10. A computer readable storage medium, storing a computer program, wherein the computer program is executed by a processor to perform the method as described in claim 1.
